(19) United States
(12) Patent Application Publication
(10) Pub. No.: US 2024/0092333 A1
(43) Pub. Date: Mar. 21, 2024

(54) SYSTEM FOR MONITORING VEHICLE OVERHEATED BRAKE AND BEARING

(71) Applicant: Qingguo Hou, Rowland Heights, CA (US)

(72) Inventor: Qingguo Hou, Rowland Heights, CA (US)

(21) Appl. No.: 17/949,470

(22) Filed: Sep. 21, 2022

(51) Int. Cl. B60T 17/22; A62C 3/07; B60Q 9/00; B60T 17/18; F16D 66/00; G01K 13/08

(52) U.S. Cl. CPC B60T 17/22; A62C 3/07; B60Q 9/00; B60T 17/18; F16D 66/00; G01K 13/08; F16D 2066/001

(57) ABSTRACT

A system for monitoring vehicle overheated brake includes at least one sensor unit arranged on an axle of a tire mounted on the vehicle; a brake mechanism arranged on one side of the sensor unit; and a data module communicated with the sensor unit; wherein the sensor unit detects a temperature of the brake mechanism and the data module creates a first warning signal when the temperature of the brake mechanism meets a predetermined limit.

### FIELD OF THE DISCLOSURE

The present disclosure relates to a monitoring system, and more particularly, to a vehicle overheated brake and bearing monitoring system adapted to create at least one warning signal in response to an overheated brake condition corresponding to the vehicle overheated brake and bearing of the vehicle.

### BACKGROUND OF THE DISCLOSURE

Generally, the reasons to cause tires overheated are the following: first, the abnormal high temperature of the brake device due to continuous overuse of the brake device or lack of reasonable adjustment of the brake device, resulting in abnormal friction and overheating of the brake device, which in turn causes the tire overheated. The second is the abnormal high temperature at the end of the axle due to loss of lubrication of bearings because of seal failure, or bearing damage, causing abnormal rolling friction, forming high temperature at the end of the axle, and then causing the tire overheated.

when an abnormality occurs in the brake temperature of the tires during the running of a vehicle, this may cause an accident. There have thus been developed devices automatically monitoring the tire temperature to raise an alarm when an abnormality occurs. Various different tire monitoring devices are known in the art. The various monitoring devices are configured to sense different tire conditions such as tire pressure, temperature, revolutions, and footprint shape. One type of monitoring device is attached to the tire valve and is disposed outside the wheel. Another type of monitoring device is carried inside the wheel and may be attached to the tire or the rim. Another type of known tire monitoring device is loosely disposed within the wheel.

A drawback to these devices is that it is difficult to configure them to create an early warning signal in response to the beginning of an overheated tire condition. In some situations, a tire that is beginning to fail includes components that are frictionally moving with respect to each other. The friction generates heat that will raise the internal temperature of the tire. Overheated tire components break down and weaken the tire. Although monitoring devices configured to sense temperature will create a warning signal when the overheated tire condition has warmed the tire or the tire chamber to a certain level, they generally do not create a signal at the beginning of an overheated tire condition. Known tire monitoring devices will not create the warning signal at the beginning of an overheated tire condition when the temperature sensor of the monitoring device is not positioned close to the components that are creating the friction. With some prior art tire monitoring devices, the monitor will not generate an alarm signal until the overheated condition has warmed the area of the tire adjacent the temperature sensor or the internal chamber of the tire. Such warming takes time which allows the condition causing the overheating to worsen before it is detected. The present invention thus develops a monitoring device that is configured to sense the beginning of the overheated axle end and brake device.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies, and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, a system for monitoring vehicle overheated brake comprises: at least one sensor unit arranged on an axle of a tire mounted on a vehicle; a brake mechanism arranged on one side of the sensor unit; and a data module communicated with the sensor unit; wherein the sensor unit detects a temperature of the brake mechanism and the data module creates a first warning signal when the temperature of the brake mechanism meets a predetermined limit.

In another aspect combinable with the general implementation, the system may comprise at least one of the side warning lights wirelessly or wiredly communicated with the data module.

In another aspect combinable with the general implementation, the system may comprise at least one of the vehicle warning lights wirelessly or wiredly communicated with the data module.

In another aspect combinable with the general implementation, the system may comprise at least one of the emergency fire fighting modules communicated with the data module.

In another aspect combinable with the general implementation, the brake mechanism comprises a brake body surrounded by a lubricating oil, an inner bearing arranged on one side of the brake body, and an outer bearing arranged on an opposite side of the brake body.

In another aspect combinable with the general implementation, the brake mechanism further comprises an oil sealing covered on the inner bearing to maintain the lubricating oil to be in contact with the brake body.

In another aspect combinable with the general implementation, the brake mechanism further comprises an oil cover covered on the outer bearing to maintain the lubricating oil to be in contact with the brake body.

In another aspect combinable with the general implementation, the vehicle warning light comprises a first indicating light corresponding to a first temperature standard, a second indicating light corresponding to a second temperature standard, and a third indicating light corresponding to a third temperature standard.

In another aspect combinable with the general implementation, the first temperature standard is 100 to 200-celsius degrees, the second temperature standard is 200-260-celsius degrees, and the third temperature standard is larger than 260-celsius degrees.

In another aspect combinable with the general implementation, the first indicating light, the second indicating light, and the third indicating light comprise various of light effects to indicate the first temperature standard, the second temperature standard, and the third temperature standard.

In another aspect combinable with the general implementation, the sensor unit comprises a gyroscope sensor which is activated while the vehicle is in motion and which is deactivated while the vehicle is not in motion.

In another aspect combinable with the general implementation, the side warning light comprises a fourth indicating light corresponding to a fourth temperature standard, a fifth indicating light corresponding to a fifth temperature standard, and a sixth indicating light corresponding to a sixth temperature standard.

In another aspect combinable with the general implementation, the fourth indicating light, the fifth indicating light, and the sixth indicating light comprises various light effects to indicate the fourth temperature standard, the fifth temperature standard, and the sixth temperature standard.

In another aspect combinable with the general implementation, the system may comprise a side warning light communicated with the data module and a vehicle warning light communicated with the data module, wherein the side warning light is simultaneously activated with the vehicle warning light.

In another aspect combinable with the general implementation, the data module comprises a memory and a processor to analyze detected data detected by the sensor unit, wherein the processor compares the detected data with safety data stored inside the memory.

In another aspect combinable with the general implementation, the detected data comprises smoke level data and temperature level data, while the smoke level data and the temperature level data exceed the safety date, the processor creates a second warning signal.

In another aspect combinable with the general implementation, the emergency fire fighting module comprises automatic fire suppression equipment.

In another aspect combinable with the general implementation, the system may comprise a power generating device to provide electricity for the system.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can, in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a system for monitoring vehicle overheated brake according to an aspect of the embodiment.

FIG. 2 is a perspective view of a system for monitoring vehicle overheated brake according to an aspect of the embodiment.

FIG. 3 is a perspective view of a system for monitoring vehicle overheated brake, showing the side warning light and the vehicle warning light according to an aspect of the embodiment.

FIG. 4 is a block diagram of a system for monitoring vehicle overheated brake according to an aspect of the embodiment.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

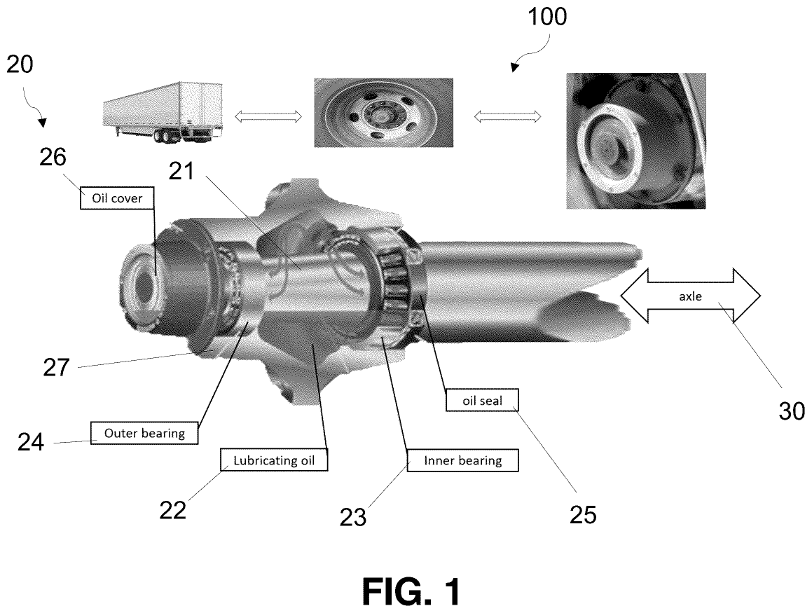

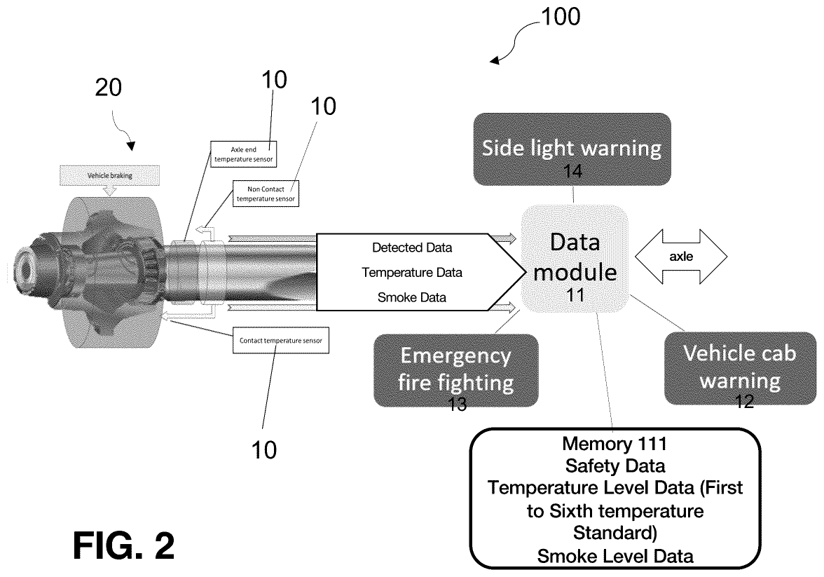

FIGS. 1-2 generally depicts a system 100 for monitoring vehicle overheated brake according to an aspect of the invention.

Referring to FIGS. 1-2, the system 100 may comprise at least one sensor unit 10 arranged on an axle 30 of a tire mounted on a vehicle and a brake mechanism 20 arranged on one side of the sensor unit 10. In one embodiment, the brake mechanism 20 comprises a brake body 21, which is surrounded by a lubricating oil 22, an inner bearing 23 arranged on one side of the brake body 21, and an outer bearing 24 arranged on an opposite side of the brake body 21, wherein the one side of the brake body 21 may be opposite of the opposite side of the brake body 21.

In one embodiment, the brake mechanism 20 further comprises an oil sealing 25 covered on the inner bearing 23 to maintain the lubricating oil 22 to be in contact with the brake body 21 and an oil cover 26 covered on the outer bearing 24 to maintain the lubricating oil 22 to be in contact with the brake body 21. In such a manner, the lubricating oil 22 may be retained inside a brake housing 27 to maintain the lubricating oil 22 to be in contact with the brake body 21, wherein the brake body 21 may be deposed inside the brake housing 27.

In one embodiment, the oil sealing 25, the inner bearing 23, the brake body 21, the oil cover 26, and the outer bearing 24 may be deposed inside the brake housing 27.

It is important to note that both the oil sealing 25 and the oil cover 26 are used to enclose the lubricating oil 22, however, the lubricating oil 22 may leak or evaporate because of the wearing of the entire brake mechanism 20. When the lubricating oil 22 is below a predetermined level, the bearings (23, 24) and axle 30 will be in contact with each other when the vehicle is moving, which will generate high temperature around the bearings (23, 24), axle 30, break body 21 and break housing 27, and further cause dangerous situations such as smokes and even burning. Thus, a sensor unit 10 should be disposed near the bearings (23, 24) to detect abnormally high temperature generated near the bearings (23, 24) to prevent the dangerous situations mentioned above from happening.

Still referring to details of FIG. 1, the axle 30 of the tire may be located along a central line of the tire, and in such a manner, the brake mechanism 20 may be located along the central line of the tire.

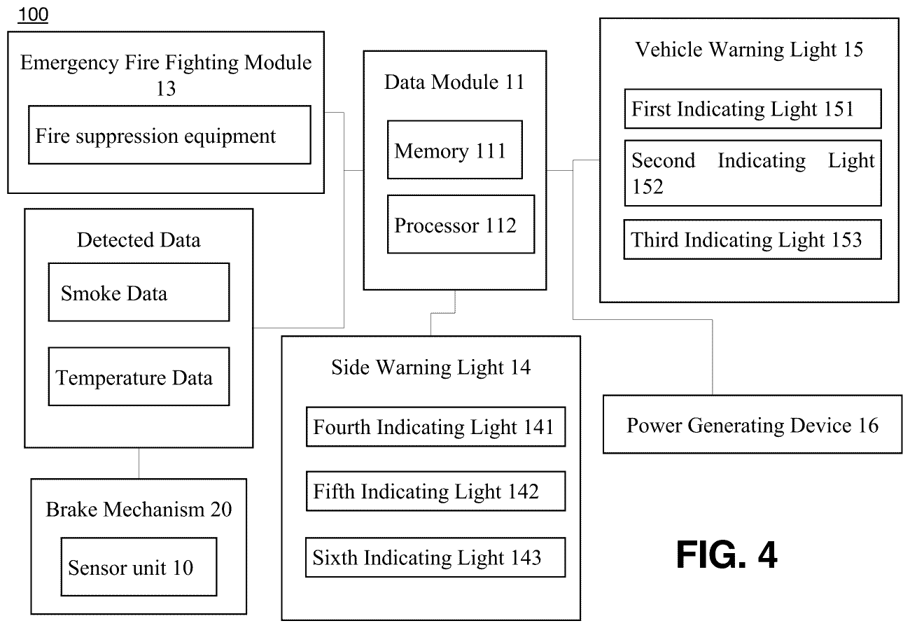

Continuing to FIG. 2, the system 100 further comprises a data module 11 wirelessly or wiredly communicated with the sensor unit 10, wherein the sensor unit 10 may detect a temperature of the brake mechanism to create detected data. In one embodiment, the detected data may comprise smoke level data and temperature level data, as shown in FIG. 4.

In one embodiment, as shown in FIG. 4, the data module 11 may further comprise a memory 111 and a processor 112 to analyze detected data detected by the sensor unit 10, wherein the processor 112 compares the detected data with safety data stored inside the memory 111. In another embodiment, the safety data may comprise temperature level data, including a first temperature standard, a second temperature standard, and a third temperature standard, wherein the first temperature standard may be 100 to 200-celsius degrees, and the second temperature standard may be 200-260-celsius degrees, and the third temperature standard may be larger than 260-celsius degrees.

In still another embodiment, the temperature level data may further comprise a fourth temperature standard, a fifth temperature standard, and a sixth temperature standard, wherein the fourth temperature standard may be equal to or different than the first temperature standard, wherein the fifth temperature standard may be equal to or different than the second temperature standard, wherein the sixth temperature standard may be equal to or different than the third temperature standard.

It should be understood that the above-described first temperature standard, the second temperature standard, the third temperature standard, the fourth temperature standard, the fifth temperature standard, and the sixth temperature standard are exemplary, and any other temperature standard can be adopted in various embodiments of this disclosure.

In still another embodiment, the safety data may comprise smoke level data, wherein the sensor unit 10 may detect the smoke generated from the brake mechanism 20. It should be noted that, in one embodiment, the detected data may comprise temperature data and smoke data, and in such a way, the processor 112 (as shown in FIG. 4) may compare the temperature data with the temperature level data, and the smoke data may be compared with the smoke level data. While the smoke data exceeds the smoke level data, the data module 11 may be activated by the processor 112 to generate a second warning signal. In still another embodiment, while the temperature data exceeds the temperature level data, the processor 112 may generate a first warning signal. In still another embodiment, when the temperature data of the brake mechanism 20 meets a predetermined limit or when the temperature data of the brake mechanism 20 exceeds the temperature level data, the data module 11 may create the first warning signal.

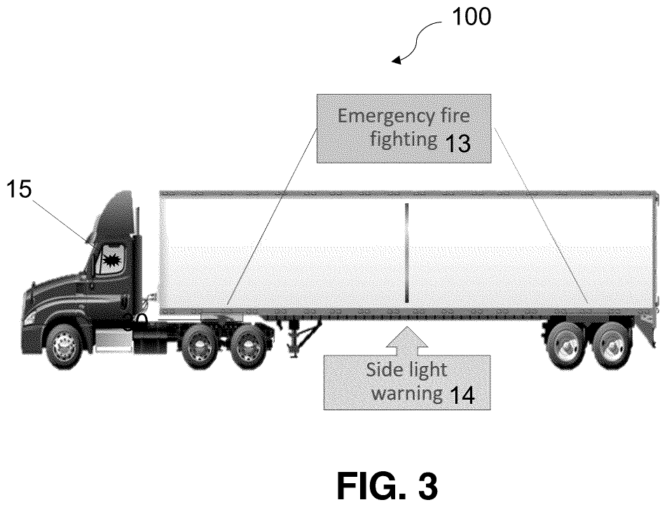

FIG. 3 generally depicts the system 100 for monitoring vehicle overheated brake mounted on a truck (vehicle) according to an aspect of the invention.

Referring to FIG. 3, the system 100 may further comprise a side warning light 14 wirelessly or wiredly communicated with the data module 11 (as shown in FIG. 2), wherein the side warning light 14 may be arranged around a periphery of the vehicle. In one embodiment, the side warning light 14 may be arranged on a top portion of the vehicle and a bottom portion of the vehicle. In another embodiment, the side warning light 14 may be arranged on a top portion of the vehicle or a bottom portion of the vehicle.

In still another embodiment, as shown in FIG. 4, the system 100 may further comprise a vehicle warning light 15 wirelessly or wiredly communicated with the data module 11, wherein the vehicle warning light 15 may be arranged in a driver's room and in such a manner, the driver may receive the abnormal status of the vehicle and make a corresponding response.

Continuing to FIG. 3 and FIG. 4, the system 100 may further comprise an emergency fire fighting module 13 communicated with the data module 11, wherein the emergency fire fighting module 13 may be arranged adjacent to the tires of the vehicle to extinguish the fire generated from the brake mechanism. In one embodiment, the emergency fire fighting module 13 may comprise automatic fire suppression equipment.

FIG. 4 generally depicts the system 100 for monitoring vehicle overheated brake according to an aspect of the invention.

Referring to FIG. 4, the vehicle warning light 15 may comprise a first indicating light 151 corresponding to a first temperature standard, a second indicating light 152 corresponding to a second temperature standard, and a third indicating light 153 corresponding to a third temperature standard. In one embodiment, the first temperature standard, the second temperature standard, and the third temperature standard may be stored in the memory 111, wherein the first temperature standard is 100 to 200-celsius degrees, and the second temperature standard is 200-260-celsius degrees, and the third temperature standard is larger than 260-celsius degrees.

In one embodiment, the first indicating light 151, the second indicating light 152, and the third indicating light 153 comprises various of light effects to indicate the first temperature standard, the second temperature standard, and the third temperature standard, wherein the light effects may be the blue light effect, the yellow light effects, the orange light effect, and the red light effects.

Referring to details of FIG. 4, the sensor unit 10 may further comprise a gyroscope sensor that is activated while the vehicle is in motion and which is deactivated while the vehicle is not in motion.

It should be understood that the above-described sensor unit 10 is exemplary and any other sensor unit can be adopted in various embodiments of this disclosure.

In one embodiment, the side warning light 14 may comprise a fourth indicating light 141 corresponding to a fourth temperature standard, a fifth indicating light 142 corresponding to a fifth temperature standard, and a sixth indicating light 143 corresponding to a sixth temperature standard. In one embodiment, the fourth temperature standard, the fifth temperature standard, and the sixth temperature standard may be stored in the memory 111, wherein the fourth temperature standard is 100 to 200-celsius degrees, and the fifth temperature standard is 200-260-celsius degrees, and the sixth temperature standard is larger than 260-celsius degrees.

In another embodiment, the fourth indicating light 141, the fifth indicating light 142, and the sixth indicating light 143 may comprise various light effects to indicate the fourth temperature standard, the fifth temperature standard, and the sixth temperature standard.

In one embodiment, the fourth indicating light 141, the fifth indicating light 142, and the sixth indicating light 143 comprises various of light effects to indicate the fourth temperature standard, the fifth temperature standard, and the sixth temperature standard, wherein the light effects may be the blue light effect, the yellow light effects, the orange light effect, and the red light effects.

It should be understood that the above-described light effects are exemplary and any other light effects can be adopted in various embodiments of this disclosure.

In still another embodiment, the side warning light 14 may be communicated with the data module 11, and the vehicle warning light 15 may be communicated with the data module 11, wherein the side warning light 14 may be simultaneously activated with the vehicle warning light 15.

It should be noted that, in one embodiment, the system 100 may further comprise a power generating device 16 to provide electricity for the system.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of the system for monitoring vehicle overheated brakes have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalents within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted, and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material, or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements that are literally set forth but all equivalent structure, material, or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can, in some cases be excised from the combination and that the claimed combination may be directed to a subcombination or variation of a subcombination.

What is claimed is:

1. A system for monitoring vehicle overheated brake, comprising:
at least one sensor unit arranged on an axle of a tire mounted on a vehicle;
a brake mechanism arranged on one side of the sensor unit; and
a data module communicated with the sensor unit;
wherein the brake mechanism comprises a brake body surrounded by a lubricating oil, an inner bearing arranged on one side of the brake body, and an outer bearing arranged on an opposite side of the brake body;
wherein said at least one sensor unit detects a temperature near the inner bearing, outer bearing and the brake mechanism and the data module creates a first warning signal when the temperature of the brake mechanism meets a predetermined limit.

2. The system of claim 1, further comprising a side warning light wirelessly or wiredly communicated with the data module.

3. The system of claim 1, further comprising a vehicle warning light wirelessly or wiredly communicated with the data module.

4. The system of claim 1, further comprising an emergency fire fighting module communicated with the data module.

5. The system of claim 1, wherein the brake mechanism further comprises an oil sealing covered on the inner bearing to maintain the lubricating oil to be in contact with the brake body.

6. The system of claim 1, wherein the brake mechanism further comprises an oil cover covered on the outer bearing to maintain the lubricating oil to be in contact with the brake body.

7. The system of claim 3, wherein the vehicle warning light comprises a first indicating light corresponding to a first temperature standard, a second indicating light corresponding to a second temperature standard, and a third indicating light corresponding to a third temperature standard.

8. The system of claim 7, wherein the first temperature standard is 100 to 200-celsius degrees, and the second temperature standard is 200-260-celsius degrees, and the third temperature standard is larger than 260-celsius degrees.

9. The system of claim 7, wherein the first indicating light, the second indicating light, and the third indicating light comprise various of light effects to indicate the first temperature standard, the second temperature standard, and the third temperature standard.

10. The system of claim 1, wherein the sensor unit comprises a gyroscope sensor which is activated while the vehicle is in motion and which is deactivated while the vehicle is not in motion.

11. The system of claim 2, wherein the side warning light comprises a fourth indicating light corresponding to a fourth temperature standard, a fifth indicating light corresponding to a fifth temperature standard, and a sixth indicating light corresponding to a sixth temperature standard.

12. The system of claim 11, wherein the fourth indicating light, the fifth indicating light, and the sixth indicating light comprise various light effects to indicate the fourth temperature standard, the fifth temperature standard, and the sixth temperature standard.

13. The system of claim 1, further comprising a side warning light communicated with the data module and a vehicle warning light communicated with the data module, wherein the side warning light is simultaneously activated with the vehicle warning light.

14. The system of claim 1, wherein the data module comprises a memory and a processor to analyze detected data detected by the sensor unit, wherein the processor compares the detected data with safety data stored in the memory.

15. The system of claim 14, wherein the detected data comprises smoke data and temperature data, while the smoke data and the temperature data exceed the safety date, the processor creates a second warning signal.

16. The system of claim 4, wherein the emergency fire fighting module comprises automatic fire suppression equipment.

17. The system of claim 1, further comprising a power generating device to provide electricity for the system.

18. The system of claim 1, wherein the predetermined limit comprises a first temperature standard of 100 to 200-celsius degrees, a second temperature standard of 200-260-celsius degrees, and a third temperature standard of larger than 260-celsius degrees.

19. The system of claim 1, wherein the predetermined limit comprises a fourth temperature standard of 100 to 200-celsius degrees, a fifth temperature standard of 200-260-celsius degrees, and a sixth temperature standard of larger than 260-celsius degrees.
